(19) United States
(12) Patent Application Publication
(10) Pub. No.: US 2012/0194512 A1
(43) Pub. Date: Aug. 2, 2012

(54) THREE-DIMENSIONAL IMAGE DATA DISPLAY CONTROLLER AND THREE-DIMENSIONAL IMAGE DATA DISPLAY SYSTEM

(75) Inventors: Kyoung-Man Kim, Suwon-si (KR); Jong-Ho Roh, Yongin-si (KR); Jong-Jin Lee, Seoul (KR)

(73) Assignee: Samsung Electronics Co., Ltd.

(21) Appl. No.: 13/348,198

(22) Filed: Jan. 11, 2012

(30) Foreign Application Priority Data
Jan. 31, 2011 (KR) 10-2011-0009203

(51) Int. Cl. G06T 15/00

(52) U.S. Cl. 345/419

(57) ABSTRACT

A display controller can include a blending coefficient storing unit and an image mixing unit. The blending coefficient storing unit can store blending coefficients. The image mixing unit can receive left-eye image data and right-eye image data, and generate three-dimensional image data by performing a blending operation on the left-eye image data and the right-eye image data using the blending coefficients stored in the blending coefficient storing unit.

### CROSS-REFERENCE TO RELATED APPLICATIONS

This U.S. non-provisional application claims the benefit of priority under 35 U.S.C. §119 to Korean Patent Application No. 2011-0009203 filed on Jan. 31, 2011 in the Korean Intellectual Property Office (KIPO), the entire content of which is incorporated herein by reference in its entirety.

### BACKGROUND

1. Technical Field

Example embodiments according to the inventive concept relate to display devices. More particularly, example embodiments according to the inventive concept relate to display devices and display systems.

2. Description of the Related Art

A conventional display device can display a two-dimensional image. However, a display device has been recently researched and developed to display a three-dimensional image or a stereoscopic image. Such a three-dimensional display device may display the three-dimensional image with or without glasses by providing different images to left and right eyes.

A conventional display may include a dedicated image formatter to generate three-dimensional image data based on left-eye image data and right-eye image data. The dedicated image formatter may perform an interleaving operation on the left-eye image data and the right-eye image data to generate the three-dimensional image data. The dedicated image formatter may be implemented as a separate chip.

### SUMMARY

Some example embodiments according to the inventive concept provide a display controller that supports a three-dimensional image mode without addition of a complicated circuit.

Some example embodiments according to the inventive concept provide a display controller that displays a three-dimensional image without addition of a complicated circuit.

According to example embodiments according to the inventive concept, a display controller includes a blending coefficient storing unit and an image mixing unit. The blending coefficient storing unit stores blending coefficients. The image mixing unit receives left-eye image data and right-eye image data, and generates three-dimensional image data by performing a blending operation on the left-eye image data and the right-eye image data using the blending coefficients stored in the blending coefficient storing unit.

In some embodiments according to the inventive concept, the blending coefficient storing unit may include a register configured to store the blending coefficients. Each of the blending coefficients stored in the register may correspond to one pixel.

In some embodiments according to the inventive concept, the blending coefficient storing unit may include a register configured to store the blending coefficients. Each of the blending coefficients stored in the register may correspond to one sub-pixel.

In some embodiments according to the inventive concept, the display controller may further include a timing generator configured to generate a frame start signal indicating a start of a frame of the three-dimensional image data and a line start signal indicating a start of a line of the three-dimensional image data.

In some embodiments according to the inventive concept, the blending coefficients may include odd frame blending coefficients corresponding to an odd frame of the three-dimensional image data and even frame blending coefficients corresponding to an even frame of the three-dimensional image data. The blending coefficient storing unit may include a selection signal generator configured to receive the frame start signal from the timing generator, and to generate a selection signal in response to the frame start signal, a first register configured to store the odd frame blending coefficients, a second register configured to store the even frame blending coefficients, and a selector configured to selectively provide the odd frame blending coefficients or the even frame blending coefficients to the image mixing unit in response to the selection signal.

In some embodiments according to the inventive concept, the blending coefficients may include odd line blending coefficients corresponding to an odd line of the three-dimensional image data and even line blending coefficients corresponding to an even line of the three-dimensional image data. The blending coefficient storing unit may include a selection signal generator configured to receive the line start signal from the timing generator, and to generate a selection signal in response to the line start signal, a first register configured to store the odd line blending coefficients, a second register configured to store the even line blending coefficients, and a selector configured to selectively provide the odd line blending coefficients or the even line blending coefficients to the image mixing unit in response to the selection signal.

In some embodiments according to the inventive concept, the display controller may further include an output interface unit configured to provide the three-dimensional image data to an external display device.

In some embodiments according to the inventive concept, the display controller may further include a first direct memory access unit configured to receive the left-eye image data by directly accessing an external memory device, and a second direct memory access unit configured to receive the right-eye image data by directly accessing the external memory device.

In some embodiments according to the inventive concept, the image mixing unit may perform an alpha blending operation as the blending operation.

In some embodiments according to the inventive concept, the image mixing unit may perform the blending operation using an equation,

$${}_{“} S I D = {\frac{1}{MAX - MIN} [ L I D * ( B C - MIN ) + R I D * ( MAX - B C ) ]}_{”} ,$$

where SID represents the three-dimensional image data, LID represents the left-eye image data, RID represents the right-eye image data, BC represents the blending coefficients, MAX represents a maximum value of the blending coefficients, and MIN represents a minimum value of the blending coefficients.

According to example embodiments according to the inventive concept, a display system includes a display controller and a display device. The display controller receives left-eye image data and right-eye image data, stores blending coefficients, and generates three-dimensional image data by performing a blending operation on the left-eye image data and the right-eye image data using the blending coefficients. The display device displays a three-dimensional image based on the three-dimensional image data.

In some embodiments according to the inventive concept, the display controller may alternately provide, as the three-dimensional image data, the left-eye image data and the right-eye image data to the display device on a pixel basis, and the display device may display the three-dimensional image based on the three-dimensional image data by using a parallax barrier or a lenticular lens.

In some embodiments according to the inventive concept, the display controller may alternately provide, as the three-dimensional image data, the left-eye image data and the right-eye image data to the display device on a sub-pixel basis, and the display device may display the three-dimensional image based on the three-dimensional image data by using a parallax barrier or a lenticular lens.

In some embodiments according to the inventive concept, the display controller may alternately provide, as the three-dimensional image data, the left-eye image data and the right-eye image data to the display device on a line basis, and the display device may display the three-dimensional image based on the three-dimensional image data by using polarized glasses.

In some embodiments according to the inventive concept, the display controller may alternately provide, as the three-dimensional image data, the left-eye image data and the right-eye image data to the display device on a frame basis, and the display device may display the three-dimensional image based on the three-dimensional image data by using shutter glasses.

As described above, a display controller and a display system according to example embodiments according to the inventive concept may support a three-dimensional image mode without addition of a complicated circuit. Further, a display controller and a display system according to example embodiments according to the inventive concept may display a three-dimensional image in various manners.

### BRIEF DESCRIPTION OF THE DRAWINGS

Illustrative, non-limiting example embodiments according to the inventive concept will be more clearly understood from the following detailed description taken in conjunction with the accompanying drawings.

FIG. 1 is a block diagram illustrating a display controller according to example embodiments according to the inventive concept.

FIG. 2 is a block diagram illustrating a display controller according to example embodiments according to the inventive concept.

FIG. 3 is a diagram for describing an example of a blending operation performed by a display controller of FIG. 2.

FIG. 4 is a diagram illustrating an example of a display system including a display controller of FIG. 2.

FIG. 5 is a diagram illustrating another example of a display system including a display controller of FIG. 2.

FIG. 6 is a block diagram illustrating a display controller according to example embodiments according to the inventive concept.

FIG. 7 is a diagram for describing an example of a blending operation performed by a display controller of FIG. 6.

FIG. 8 is a diagram illustrating an example of a display system including a display controller of FIG. 6.

FIG. 9 is a diagram illustrating another example of a display system including a display controller of FIG. 6.

FIG. 10 is a block diagram illustrating a display controller according to example embodiments according to the inventive concept.

FIG. 11 is a diagram for describing an example of a blending operation performed by a display controller of FIG. 10.

FIGS. 12A and 12B are diagrams illustrating an example of a display system including a display controller of FIG. 10.

FIG. 13 is a diagram for describing another example of a blending operation performed by a display controller of FIG. 10.

FIG. 14 is a diagram illustrating another example of a display system including a display controller of FIG. 10.

FIG. 15 is a diagram for describing still another example of a blending operation performed by a display controller of FIG. 10.

FIGS. 16A and 16B are diagrams illustrating still another example of a display system including a display controller of FIG. 10.

FIG. 17 is a block diagram illustrating a display controller according to example embodiments according to the inventive concept.

FIG. 18 is a diagram for describing an example of a blending operation performed by a display controller of FIG. 17.

FIGS. 19A and 19B are diagrams illustrating an example of a display system including a display controller of FIG. 17.

FIG. 20 is a block diagram illustrating an application processor according to example embodiments according to the inventive concept.

FIG. 21 is a block diagram illustrating a mobile system according to example embodiments according to the inventive concept.

### DETAILED DESCRIPTION OF THE EMBODIMENTS ACCORDING TO THE INVENTIVE CONCEPT

Various example embodiments according to the inventive concept will be described more fully hereinafter with reference to the accompanying drawings, in which some example embodiments according to the inventive concept are shown. The present inventive concept may, however, be embodied in many different forms and should not be construed as limited to the example embodiments according to the inventive concept set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper,” “left,” “right,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments according to the inventive concept only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is a block diagram illustrating a display controller according to example embodiments according to the inventive concept.

Referring to FIG. 1, a display controller 100 includes an image mixing unit 110 and a blending coefficient storing unit 130.

The blending coefficient storing unit 130 stores blending coefficients BC, and provides the blending coefficients BC to the image mixing unit 110. The blending coefficients BC may be used for the image mixing unit 110 to perform a blending operation. In some embodiments according to the inventive concept, when the display controller 100 is initialized, or when a type of a three-dimensional image mode supported by the display controller 100 is determined, the blending coefficients BC may be provided from an internal or external nonvolatile memory device to the blending coefficient storing unit 130. For example, once the type of the three-dimensional image mode is determined as one of a parallax barrier type, a lenticular lens type, a polarized glasses type and a shutter glasses type, the blending coefficient storing unit 130 may receive the blending coefficients BC corresponding to the determined type from the nonvolatile memory device, and may store the received blending coefficients BC. In other embodiments according to the inventive concept, the blending coefficient storing unit 130 may include a nonvolatile memory device that retains data even when the power is not supplied. In this case, the blending coefficient storing unit 130 may store the blending coefficients BC corresponding to at least one type of the three-dimensional image mode before the display controller 100 is initialized. According to example embodiments according to the inventive concept, each blending coefficient BC may correspond to one pixel or one sub-pixel.

The image mixing unit 110 receives left-eye image data LID and right-eye image data RID, and generates three-dimensional image data SID by performing a blending operation on the left-eye image data LID and the right-eye image data RID using the blending coefficients BC stored in the blending coefficient storing unit 130. In some embodiments according to the inventive concept, the image mixing unit 110 may perform an alpha blending operation as the blending operation. For example, the image mixing unit 110 may perform the blending operation using Equation 1.

$$S I D = \frac{1}{MAX - MIN} [ L I D * ( B C - MIN ) + R I D * ( MAX - B C ) ] \qquad [ Equation 1 ]$$

Here, SID represents the three-dimensional image data, LID represents the left-eye image data, RID represents the right-eye image data, BC represents the blending coefficients, MAX represents the maximum value of the blending coefficients, and MIN represents the minimum value of the blending coefficients.

For example, in a case where MAX is “1” and MIN is “0”, the image mixing unit 110 may generate the three-dimensional image data SID using Equation 2.

SID=LID*BC+RID*(1−BC) [Equation 2]

In this case, if a value of a blending coefficient corresponding to a pixel or a sub-pixel is “1”, the three-dimensional image data SID corresponding to the pixel or the sub-pixel may be equal to the value of the left-eye image data LID. If a value of a blending coefficient corresponding to a pixel or a sub-pixel is “0”, the three-dimensional image data SID corresponding to the pixel or the sub-pixel may be equal to the value of the right-eye image data RID.

In another case where MAX is “0xFF” and MIN is “0x00”, the image mixing unit 110 may generate the three-dimensional image data SID using Equation 3.

$$S I D = \frac{1}{0 \times F F} [ L I D * B C + R I D * ( 0 \times F F - B C ) ] \qquad [ Equation 3 ]$$

In this case, if a value of a blending coefficient corresponding to a pixel or a sub-pixel is “0xFF”, the three-dimensional image data SID corresponding to the pixel or the sub-pixel may be equal to the value of the left-eye image data LID. If a value of a blending coefficient corresponding to a pixel or a sub-pixel is “0x00”, the three-dimensional image data SID corresponding to the pixel or the sub-pixel may be equal to the value of the right-eye image data RID.

The image mixing unit 110 may selectively output the left-eye image data LID or the right-eye image data RID as the three-dimensional image data SID by performing such an operation, or the blending operation. The image mixing unit 110 may be implemented in either hardware or software.

The display controller 100 according to example embodiments according to the inventive concept may support the three-dimensional image mode such that the display controller 100 provides the three-dimensional image data SID by using the simple blending operation. Accordingly, the display controller 100 may support the three-dimensional image mode without addition of a complicated circuit. Further, the display controller 100 according to example embodiments according to the inventive concept may support various types of the three-dimensional image mode, such as the parallax barrier type, the lenticular lens type, the polarized glasses type, the shutter glasses type, etc., by setting the blending coefficients BC stored in the blending coefficient storing unit 130 to appropriate values.

In some embodiments according to the inventive concept, the display controller 100 may further include a direct memory access (DMA) unit that reads the left-eye image data LID and the right-eye image data RID by directly accessing an external memory device. In some embodiments according to the inventive concept, the display controller 100 may further include an output interface unit for providing the three-dimensional image data SID to an external display device, and a timing generator for controlling an operation timing of the display device.

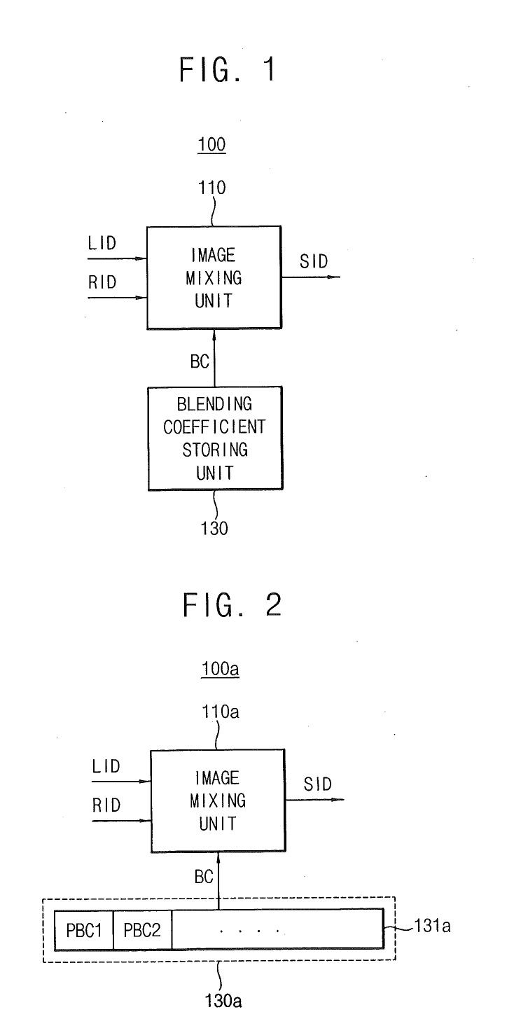

FIG. 2 is a block diagram illustrating a display controller according to example embodiments according to the inventive concept.

Referring to FIG. 2, a display controller 100a includes an image mixing unit 110a and a blending coefficient storing unit 130a.

The blending coefficient storing unit 130a stores blending coefficients BC, and provides the blending coefficients BC to the image mixing unit 110a. The blending coefficients BC may be pixel blending coefficients PBC1 and PBC2, each of which corresponds to one pixel included in an external display device. The blending coefficient storing unit 130a may include a register 131a that stores the pixel blending coefficients PBC1 and PBC2 respectively corresponding to the pixels. The register 131a may have various sizes according to example embodiments according to the inventive concept. For example, the register 131a may have a size corresponding to two pixels. That is, the register 131a may have a suitable size to store two pixel blending coefficients PBC1 and PBC2 that are used to perform a blending operation for the two pixels. In another example, the register 131a may have a size corresponding to three or more pixels. In still another example, the register 131a may have a size corresponding to one line, or one row of pixels. In still another example, the register 131a may have a size corresponding to one frame, or the entire pixels included in a pixel array.

The image mixing unit 110a receives left-eye image data LID and right-eye image data RID, and generates three-dimensional image data SID by performing the blending operation on the left-eye image data LID and the right-eye image data RID using the blending coefficients BC provided from the blending coefficient storing unit 130a. The image mixing unit 110a may perform the blending operation on a pixel basis.

For example, the image mixing unit 110a may receive first and second pixel blending coefficients PBC1 and PBC2 respectively corresponding to first and second pixels from the blending coefficient storing unit 130a. The image mixing unit 110a may generate the three-dimensional image data SID corresponding to the first pixel by performing the blending operation on the left-eye image data LID corresponding to the first pixel and the right-eye image data RID corresponding to the first pixel using the first pixel blending coefficient PBC1. Further, the image mixing unit 110a may generate the three-dimensional image data SID corresponding to the second pixel by performing the blending operation on the left-eye image data LID corresponding to the second pixel and the right-eye image data RID corresponding to the second pixel using the second pixel blending coefficient PBC2.

The blending operation may be sequentially performed with respect to a plurality of pixels, or may be substantially simultaneously performed. For example, the blending operation for two or more pixels may be substantially simultaneously performed in parallel.

As described above, the display controller 100a according to example embodiments according to the inventive concept may support a three-dimensional image mode without addition of a complicated circuit by performing the blending operation.

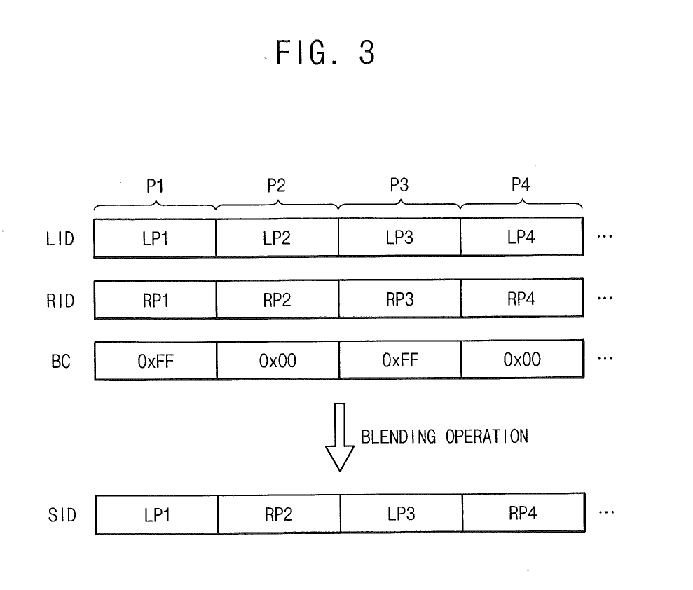

FIG. 3 is a diagram for describing an example of a blending operation performed by a display controller of FIG. 2.

Referring to FIGS. 2 and 3, the image mixing unit 110a may receive, as left-eye image data LID, first through fourth left-eye pixel data LP1, LP2, LP3 and LP4 respectively corresponding to first through fourth pixels P1, P2, P3 and P4, and may receive, as right-eye image data RID, first through fourth right-eye pixel data RP1, RP2, RP3 and RP4 respectively corresponding to the first through fourth pixels P1, P2, P3 and P4. Further, the image mixing unit 110a may receive, as blending coefficients BC, first through fourth pixel blending coefficients respectively corresponding to the first through fourth pixels P1, P2, P3 and P4.

For example, the maximum value of the blending coefficients BC may be “0xFF”, the minimum value of the blending coefficients BC may be “0x00”, and the first through fourth pixel blending coefficients may be “0xFF”, “0x00”, “0xFF” and “0x00”, respectively. In this case, by performing a blending operation, the image mixing unit 110a may output the first left-eye pixel data LP1 as three-dimensional image data SID for the first pixel P1, the second right-eye pixel data RP2 as the three-dimensional image data SID for the second pixel P2, the third left-eye pixel data LP3 as the three-dimensional image data SID for the third pixel P3, and the fourth right-eye pixel data RP4 as the three-dimensional image data SID for the fourth pixel P4.

The blending operation for the pixels P1, P2, P3 and P4 may be sequentially performed, or may be substantially simultaneously performed. For example, the blending operation for one line may be substantially simultaneously performed in parallel.

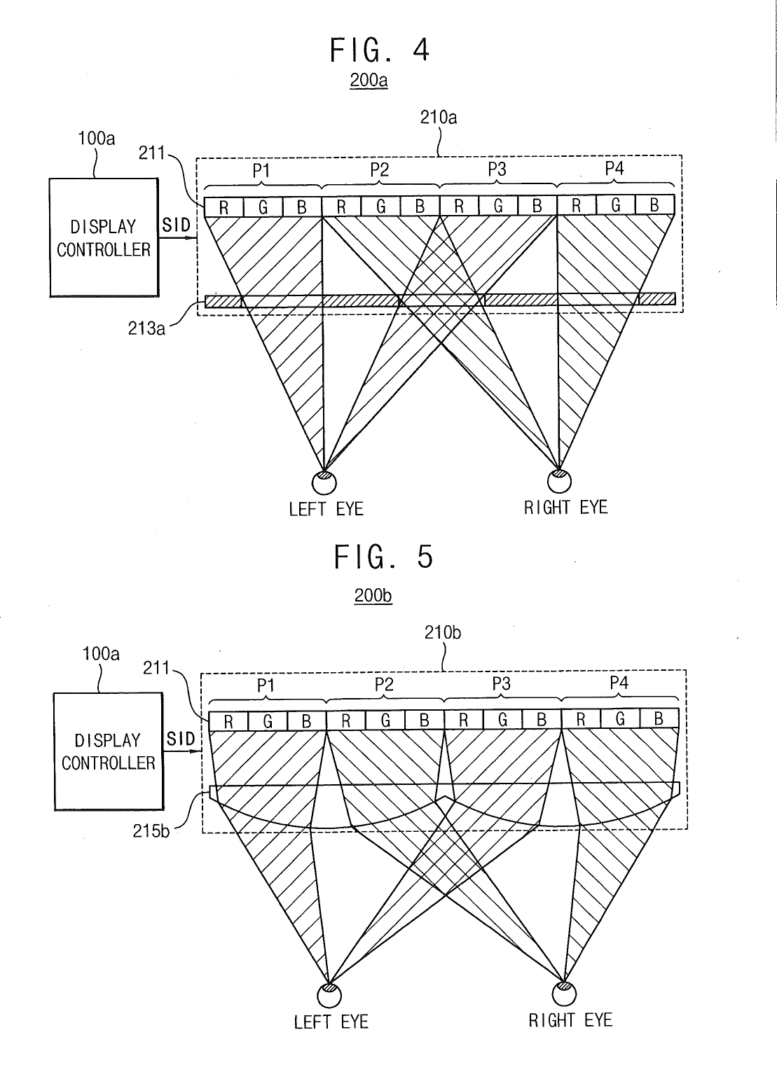

FIG. 4 is a diagram illustrating an example of a display system including a display controller of FIG. 2.

Referring to FIGS. 2, 3 and 4, a display system 200a includes a display controller 100a and a display device 210a.

The display controller 100a receives left-eye image data LID and right-eye image data RID, and performs a blending operation on the left-eye image data LID and the right-eye image data RID using pixel blending coefficients PBC1 and PBC2 on a pixel basis. Thus, the display controller 100a may alternately provide, as three-dimensional image data SID, the left-eye image data LID and the right-eye image data RID to the display device 210a on a pixel basis. For example, the display controller 100a may provide a first left-eye pixel data LP1 as the three-dimensional image data SID for a first pixel P1, a second right-eye pixel data RP2 as the three-dimensional image data SID for a second pixel P2, a third left-eye pixel data LP3 as the three-dimensional image data SID for a third pixel P3, and a fourth right-eye pixel data RP4 as the three-dimensional image data SID for a fourth pixel P4.

The display device 210a receives the three-dimensional image data SID from the display controller 100a, and displays a three-dimensional image based on the three-dimensional image data SID. The display device 210a may include a display panel 211 including a plurality of pixels P1, P2, P3 and P4, and a parallax barrier 213a having opening portions and blocking portions. The display panel 211 may be implemented by one of various panels, such as a liquid crystal display (LCD) panel, an organic light emitting device (OLED) panel, a plasma display panel (PDP), an electroluminescence device (EL) panel, etc. Although FIG. 4 illustrates four pixels P1, P2, P3 and P4 for convenience of illustration, the display panel 211 may include a plurality of pixels arranged in a matrix form having a plurality of rows and a plurality of columns.

The parallax barrier 213a may provide a left-eye image corresponding to the left-eye image data LID to a left-eye of a user, and may provide a right-eye image corresponding to the right-eye image data RID to a right-eye of the user. For example, an opening portion of the parallax barrier 213a may be located between the first pixel P1 and the left-eye of the user, and thus an image displayed by first pixel P1 may be provided to the left-eye. Further, a blocking portion of the parallax barrier 213a may be located between the first pixel P1 and the right-eye of the user, and thus the image displayed by first pixel P1 may not be provided to the right-eye. Similarly, by the opening portions and the blocking portions of the parallax barrier 213a, an image displayed by the second pixel P2 may be provided only to the right-eye, an image displayed by the third pixel P3 may be provided only to the left-eye, and an image displayed by the fourth pixel P4 may be provided only to the right-eye. In some embodiments according to the inventive concept, the parallax barrier 213a may alternately include the opening portions and the blocking portions in a row direction, and each of the opening portions and the blocking portions may be extended in a column direction.

In the display system 200a, the display controller 100a may alternately output the left-eye image data LID and the right-eye image data RID as the three-dimensional image data SID on a pixel basis by performing the blending operation, and the display device 210a may provide the left-eye image corresponding to the left-eye image data LID to the left-eye and the right-eye image corresponding to the right-eye image data RID to the right-eye by using the parallax barrier 213a. Accordingly, the display system 200a according to example embodiments according to the inventive concept may provide a three-dimensional image in a parallax barrier manner without addition of a complicated circuit.

FIG. 5 is a diagram illustrating another example of a display system including a display controller of FIG. 2.

Referring to FIGS. 2, 3 and 5, a display system 200b includes a display controller 100a and a display device 210b.

The display controller 100a may alternately provide, as three-dimensional image data SID, left-eye image data LID and right-eye image data RID to the display device 210b on a pixel basis by performing a blending operation.

The display device 210b includes a display panel 211 and a lenticular lens 215b including lenses having a predetermined curvature. The lenticular lens 215b may provide a left-eye image corresponding to the left-eye image data LID to a left-eye of a user, and may provide a right-eye image corresponding to the right-eye image data RID to a right-eye of the user. For example, images displayed by first and third pixels P1 and P3 may be refracted by the lenticular lens 215b, and may be provided to the left-eye. Further, images displayed by second and fourth pixels P2 and P4 may be refracted by the lenticular lens 215b, and may be provided to the right-eye. In some embodiments according to the inventive concept, each lens included in the lenticular lens 215b may be extended in a column direction. In other embodiments according to the inventive concept, the lenticular lens 215b may include a micro lens array having a plurality of lenses arranged in a matrix form. In this case, the lenticular lens 215b may provide a difference in vision in a vertical direction as well as a difference in vision in a horizontal direction.

In the display system 200b, the display controller 100a may alternately output the left-eye image data LID and the right-eye image data RID as the three-dimensional image data SID on a pixel basis by performing the blending operation, and the display device 210b may provide the left-eye image corresponding to the left-eye image data LID to the left-eye and the right-eye image corresponding to the right-eye image data RID to the right-eye by using the lenticular lens 215b. Accordingly, the display system 200b according to example embodiments according to the inventive concept may provide a three-dimensional image in a lenticular lens manner without addition of a complicated circuit.

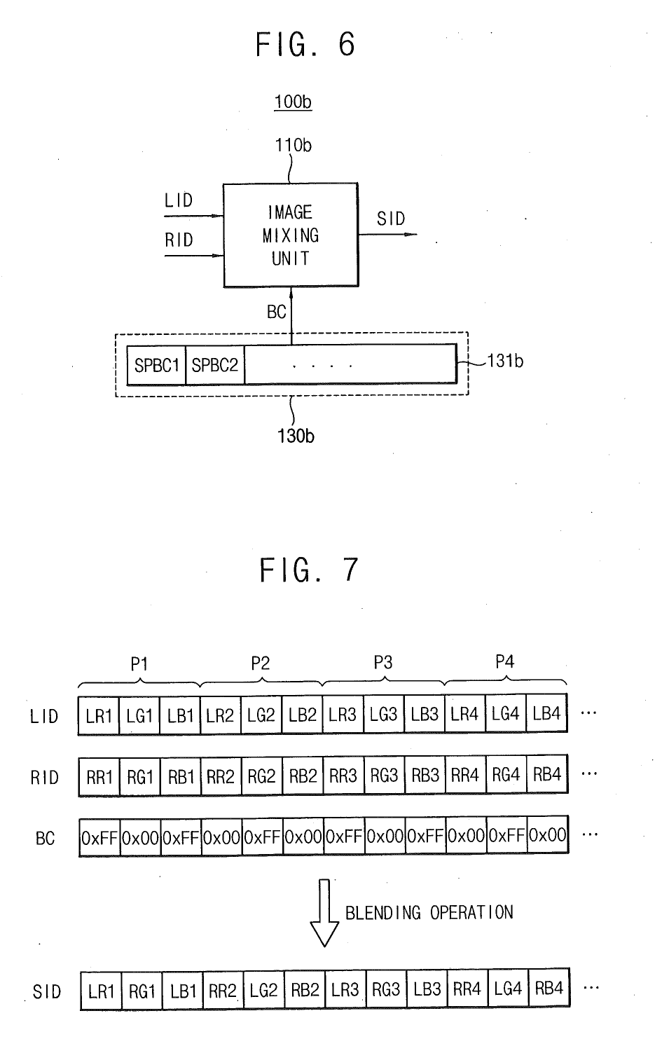

FIG. 6 is a block diagram illustrating a display controller according to example embodiments according to the inventive concept.

Referring to FIG. 6, a display controller 100b includes an image mixing unit 110b and a blending coefficient storing unit 130b.

The blending coefficient storing unit 130b stores blending coefficients BC, and provides the blending coefficients BC to the image mixing unit 110b. The blending coefficient storing unit 130b may include a register 131b that stores sub-pixel blending coefficients SPBC1 and SPBC2 respectively corresponding to sub-pixels. The register 131b may have various sizes according to example embodiments according to the inventive concept.

The image mixing unit 110b receives left-eye image data LID and right-eye image data RID, and generates three-dimensional image data SID by performing the blending operation on the left-eye image data LID and the right-eye image data RID using the blending coefficients BC provided from the blending coefficient storing unit 130b. The image mixing unit 110b may perform the blending operation on a sub-pixel basis.

For example, the image mixing unit 110b may receive first and second sub-pixel blending coefficients SPBC1 and SPBC2 respectively corresponding to first and second sub-pixels from the blending coefficient storing unit 1301). The image mixing unit 110b may generate the three-dimensional image data SID corresponding to the first sub-pixel by performing the blending operation on the left-eye image data LID corresponding to the first sub-pixel and the right-eye image data RID corresponding to the first sub-pixel using the first sub-pixel blending coefficient SPBC1. Further, the image mixing unit 110b may generate the three-dimensional image data SID corresponding to the second sub-pixel by performing the blending operation on the left-eye image data LID corresponding to the second sub-pixel and the right-eye image data RID corresponding to the second sub-pixel using the second sub-pixel blending coefficient PBC2. In other embodiments according to the inventive concept, although the blending coefficient storing unit 130b stores the sub-pixel blending coefficients SPBC1 and SPBC2, the image mixing unit 110b may perform the blending operation on a pixel basis.

The blending operation may be sequentially performed for a plurality of sub-pixels, or may be substantially simultaneously performed. For example, the blending operation for two or more sub-pixels may be substantially simultaneously performed in parallel.

As described above, the display controller 100b according to example embodiments according to the inventive concept may support a three-dimensional image mode without addition of a complicated circuit by performing the blending operation.

FIG. 7 is a diagram for describing an example of a blending operation performed by a display controller of FIG. 6.

Referring to FIGS. 6 and 7, each pixel P1, P2, P3 and P4 may include a red sub-pixel, a green sub-pixel and a blue sub-pixel. An image mixing unit 110b may receive, as left-eye image data LID, first through twelfth left-eye sub-pixel data LR1, LG1, LB1, LR2, LG2, LB2, LR3, LG3, LB3, LR4, LG4 and LB4 respectively corresponding to first through twelfth sub-pixels, and may receive, as right-eye image data RID, first through twelfth right-eye sub-pixel data RR1, RG1, RB1, RR2, RG2, RB2, RR3, RG3, RB3, RR4, RG4 and RB4 respectively corresponding to the first through twelfth sub-pixels. Further, the image mixing unit 110b may receive, as blending coefficients BC, first through twelfth sub-pixel blending coefficients respectively corresponding to the first through twelfth sub-pixels.

For example, the maximum value of the blending coefficients BC may be “0xFF”, the minimum value of the blending coefficients BC may be “0x00”, and the first through twelfth sub-pixel blending coefficients may be “0xFF”, “0x00”, “0xFF”, “0x00”, “0xFF”, “0x00”, “0xFF”, “0x00”, “0xFF”, “0x00”, “0xFF” and “0x00”, respectively. In this case, by performing a blending operation, the image mixing unit 110b may output the first, third, fifth, seventh, ninth and eleventh left-eye sub-pixel data LR1, LB1, LG2, LR3, LB3 and LG4 as three-dimensional image data SID for the first, third, fifth, seventh, ninth and eleventh sub-pixels, and the second, fourth, sixth, eighth, tenth and twelfth right-eye sub-pixel data RG1, RR2, RB2, RG3, RR4 and RB4 as the three-dimensional image data SID for the second, fourth, sixth, eighth, tenth and twelfth sub-pixels.

The blending operation for the sub-pixels may be sequentially performed, or may be substantially simultaneously performed. Although FIG. 7 illustrates an example where the blending operation is performed on a sub-pixel basis, the image mixing unit 110b may perform the blending operation on a pixel basis.

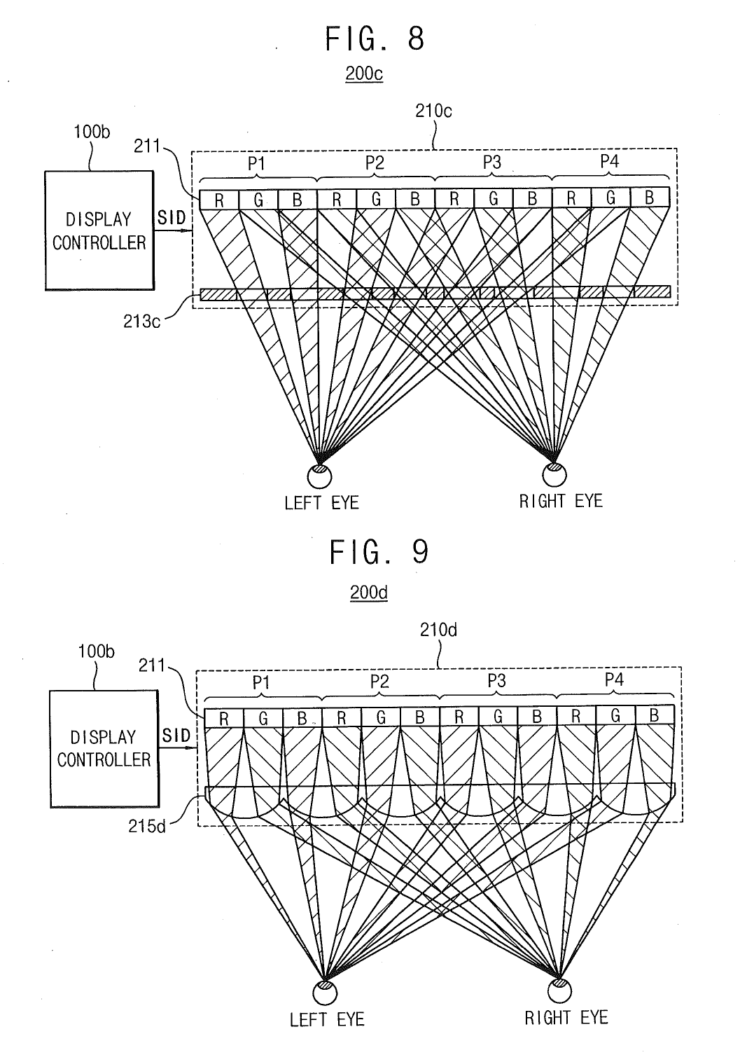

FIG. 8 is a diagram illustrating an example of a display system including a display controller of FIG. 6.

Referring to FIGS. 6, 7 and 8, a display system 200c includes a display controller 100b and a display device 210c.

The display controller 100b receives left-eye image data LID and right-eye image data RID, and performs a blending operation on the left-eye image data LID and the right-eye image data RID using sub-pixel blending coefficients SPBC1 and SPBC2 on a sub-pixel basis. Thus, the display controller 100b may alternately provide, as three-dimensional image data SID, the left-eye image data LID and the right-eye image data RID to the display device 210c on a sub-pixel basis.

The display device 210c receives the three-dimensional image data SID from the display controller 100b, and displays a three-dimensional image based on the three-dimensional image data SID. The display device 210c may include a display panel 211 and a parallax barrier 213c.

The parallax barrier 213c may provide a left-eye image corresponding to the left-eye image data LID to a left-eye of a user, and may provide a right-eye image corresponding to the right-eye image data RID to a right-eye of the user. For example, by opening portions and blocking portions of the parallax barrier 213c, images displayed by first, third, fifth, seventh, ninth and eleventh sub-pixels (e.g., red and blue sub-pixels of a first pixel P1, a green sub-pixel of a second pixel P2, red and blue sub-pixels of a third pixel P1, and a green sub-pixel of a fourth pixel P4) may be provided to the left-eye, and images displayed by second, fourth, sixth, eighth, tenth and twelfth sub-pixels (e.g., a green sub-pixel of the first pixel P1, red and blue sub-pixels of the second pixel P2, a green sub-pixel of the third pixel P1, and red and blue sub-pixels of the fourth pixel P4) may be provided to the right-eye.

In the display system 200c, the display controller 100b may alternately output the left-eye image data LID and the right-eye image data RID as the three-dimensional image data SID on a sub-pixel basis by performing the blending operation, and the display device 210c may provide the left-eye image corresponding to the left-eye image data LID to the left-eye and the right-eye image corresponding to the right-eye image data RID to the right-eye by using the parallax barrier 213c. Accordingly, the display system 200c according to example embodiments according to the inventive concept may provide a three-dimensional image in a parallax barrier manner without addition of a complicated circuit.

FIG. 9 is a diagram illustrating another example of a display system including a display controller of FIG. 6.

Referring to FIGS. 6, 7 and 9, a display system 200d includes a display controller 100b and a display device 210d.

The display controller 100b may alternately provide, as three-dimensional image data SID, left-eye image data LID and right-eye image data RID to the display device 210d on a pixel basis by performing a blending operation.

The display device 210d includes a display panel 211 and a lenticular lens 215d. The lenticular lens 215d may provide a left-eye image corresponding to the left-eye image data LID to a left-eye of a user, and may provide a right-eye image corresponding to the right-eye image data RID to a right-eye of the user. For example, images displayed by first, third, fifth, seventh, ninth and eleventh sub-pixels may be refracted by the lenticular lens 215d to reach the left-eye, and images displayed by second, fourth, sixth, eighth, tenth and twelfth sub-pixels may be refracted by the lenticular lens 215d to reach the right-eye.

In the display system 200d, the display controller 100b may alternately output the left-eye image data LID and the right-eye image data RID as the three-dimensional image data SID on a pixel basis by performing the blending operation, and the display device 210d may provide the left-eye image corresponding to the left-eye image data LID to the left-eye and the right-eye image corresponding to the right-eye image data RID to the right-eye by using the lenticular lens 215d. Accordingly, the display system 200d according to example embodiments according to the inventive concept may provide a three-dimensional image in a lenticular lens manner without addition of a complicated circuit.

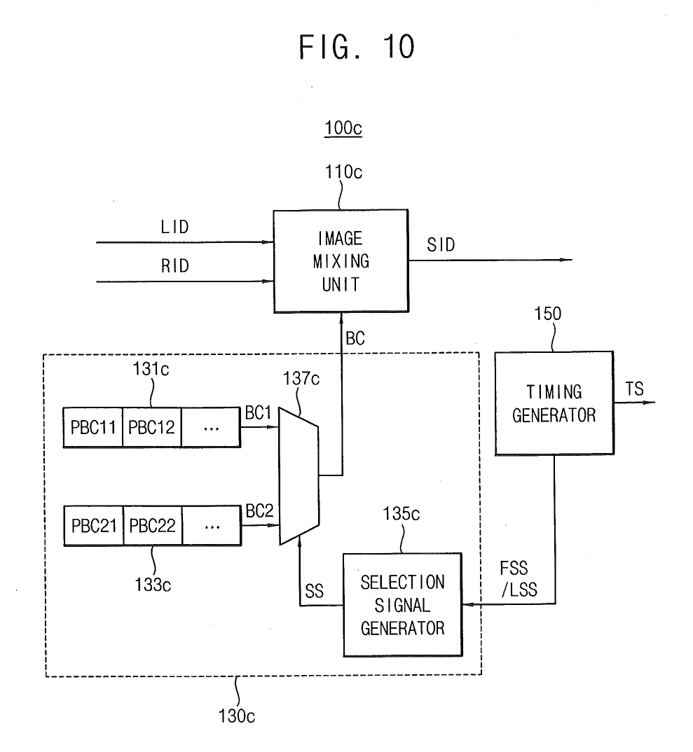

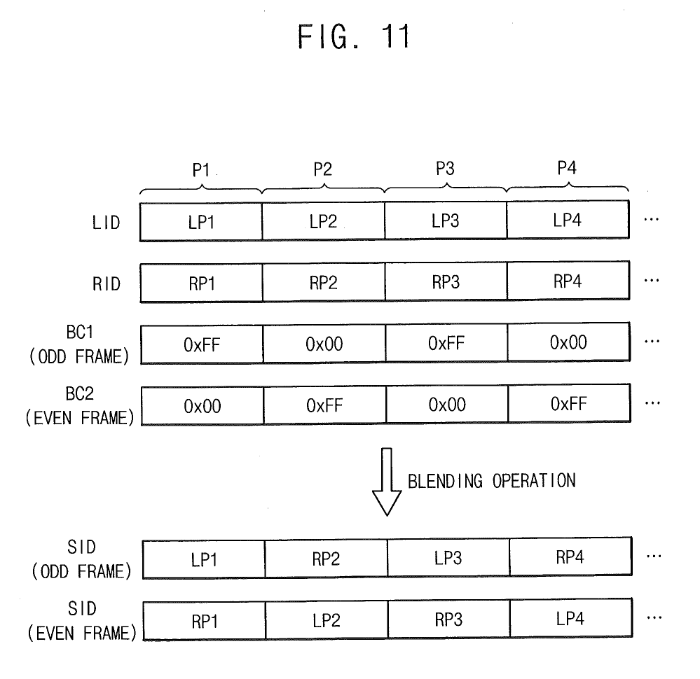

FIG. 10 is a block diagram illustrating a display controller according to example embodiments according to the inventive concept.

Referring to FIG. 10, a display controller 100c includes an image mixing unit 110c, a blending coefficient storing unit 130c and a timing generator 150.

The timing generator 150 generates a timing signal TS to control an operation timing of an external display device. For example, the timing signal TS may include a vertical synchronization signal (VSYNC), a horizontal synchronization signal (HSYNC), an enable signal, a clock signal, etc. Further, the timing generator 150 may generate a frame start signal FSS indicating a start of a frame of three-dimensional image data and a line start signal LSS indicating a start of a line of the three-dimensional image data. In some embodiments according to the inventive concept, the frame start signal FSS may be the vertical synchronization signal, and the line start signal LSS may be the horizontal synchronization signal.

The blending coefficient storing unit 130c includes a first register 131c, a second register 133c, a selection signal generator 135c and a selector 137c. The first register 131c and the second register 133c may store blending coefficients BC, each of which corresponds to one pixel included in the display device. For example, the first register 131c may store first pixel blending coefficients PBC11 and PBC12 respectively corresponding to the pixels, and the second register 133c may store second pixel blending coefficients PBC21 and PBC22 respectively corresponding to the pixels. Each of the first register 131c and the second register 133c may have various sizes according to example embodiments according to the inventive concept. The selection signal generator 135c may receive the frame start signal FSS and/or the line start signal LSS from the timing generator 150, and may generate a selection signal SS in response to the frame start signal FSS and/or the line start signal LSS. The selector 137c may receive the first pixel blending coefficients PBC11 and PBC12 as the first blending coefficients BC1 from the first register 131c, may receive the second pixel blending coefficients PBC21 and PBC22 as the second blending coefficients BC2 from the second register 133c, and may receive the selection signal SS from the selection signal generator 135c. The selector 137c may selectively provide, as the blending coefficients BS, the first blending coefficients BC1 or the second blending coefficients BC2 to the image mixing unit 110c. For example, the selector 137c may be implemented by a multiplexer.

The first blending coefficients BC1 and the second blending coefficients BC2 may be selectively used on a frame basis or a line basis. In some embodiments according to the inventive concept, the first register 131c may store odd frame blending coefficients BC1 corresponding to an odd frame, and the second register 133c may store even frame blending coefficients BC2 corresponding to an even frame. The selection signal generator 135c may change a logic level of the selection signal SS in response to the frame start signal FSS. In response to the selection signal SS, the selector 137c may output the odd frame blending coefficients BC1 as the blending coefficients BC when a blending operation for the odd frame is performed, and may output the even frame blending coefficients BC2 as the blending coefficients BC when a blending operation for the even frame is performed. Thus, the image mixing unit 110c may perform the blending operation for the odd frame using the odd frame blending coefficients BC1, and may perform the blending operation for the even frame using the even frame blending coefficients BC2.

In other embodiments according to the inventive concept, the first register 131c may store odd line blending coefficients BC1 corresponding to an odd line, and the second register 133c may store even line blending coefficients BC2 corresponding to an even line. The selection signal generator 135c may change a logic level of the selection signal SS in response to the line start signal LSS. In response to the selection signal SS, the selector 137c may output the odd line blending coefficients BC1 as the blending coefficients BC when a blending operation for the odd line is performed, and may output the even line blending coefficients BC2 as the blending coefficients BC when a blending operation for the even line is performed. Thus, the image mixing unit 110c may perform the blending operation for the odd line using the odd line blending coefficients BC1, and may perform the blending operation for the even line using the even line blending coefficients BC2.

The image mixing unit 110c receives left-eye image data LID and right-eye image data RID, and generates three-dimensional image data SID by performing the blending operation on the left-eye image data LID and the right-eye image data RID using the blending coefficients BC provided from the blending coefficient storing unit 130c. The first blending coefficients BC1 and the second blending coefficients BC2 may be alternately provided from the blending coefficient storing unit 130c to the image mixing unit 110c on a frame basis or on a line basis, and the image mixing unit 110c may perform the blending operation by selectively using the first blending coefficients BC1 or the second blending coefficients BC2.

For example, the image mixing unit 110c may perform the blending operation using the first blending coefficients BC1 in the odd frame, and may perform the blending operation using the second blending coefficients BC2 in the even frame. Accordingly, the image mixing unit 110c may output the three-dimensional image data SID where the left-eye image data LID and right-eye image data RID are interleaved in different orders with respect to the odd frame and the even frame.

In some embodiments according to the inventive concept, the image mixing unit 110c may perform the blending operation using both blending coefficients for even and odd frames as well as coefficients for even and odd lines. Accordingly, an odd frame may have a coefficient that is combined with coefficients for the even and odd lines within the odd frame. Similarly, an even frame may have a coefficient that is combined with coefficients for the even and odd lines within the even frame.

As described above, the display controller 100c may output the three-dimensional image data SID having different interleaving orders by selectively using the first blending coefficients BC1 or the second blending coefficients BC2. Accordingly, the display controller 100c may support a temporal division type three-dimensional image mode without addition of a complicated circuit.

FIG. 11 is a diagram for describing an example of a blending operation performed by a display controller of FIG. 10.

Referring to FIGS. 10 and 11, an image mixing unit 110c may receive, as left-eye image data LID, first through fourth left-eye pixel data LP1, LP2, LP3 and LP4 respectively corresponding to first through fourth pixels P1, P2, P3 and P4, and may receive, as right-eye image data RID, first through fourth right-eye pixel data RP1, RP2, RP3 and RP4 respectively corresponding to the first through fourth pixels P1, P2, P3 and P4. Further, the image mixing unit 110c may receive first pixel blending coefficients PBC11 and PBC12 respectively corresponding to the first through fourth pixels P1, P2, P3 and P4 in an odd frame, and may receive second pixel blending coefficients PBC21 and PBC22 respectively corresponding to the first through fourth pixels P1, P2, P3 and P4 in an even frame.

For example, the maximum value of the blending coefficients BC may be “0xFF”, the minimum value of the blending coefficients BC may be “0x00”, the first pixel blending coefficients PBC11 and PBC12 may be “0xFF”, “0x00”, “0xFF” and “0x00”, respectively, and the second pixel blending coefficients PBC21 and PBC22 may be “0x00”, “0xFF”, “0x00” and “0xFF”, respectively. In this case, the image mixing unit 110c may output the first left-eye pixel data LP1, the second right-eye pixel data RP2, the third left-eye pixel data LP3 and the fourth right-eye pixel data RP4 as the three-dimensional image data SID for the first through fourth pixels P1, P2, P3 and P4 in the odd frame, and may output the first right-eye pixel data RP1, the second left-eye pixel data LP2, the third right-eye pixel data RP3 and the fourth left-eye pixel data LP4 as the three-dimensional image data SID for the first through fourth pixels P1, P2, P3 and P4 in the even frame.

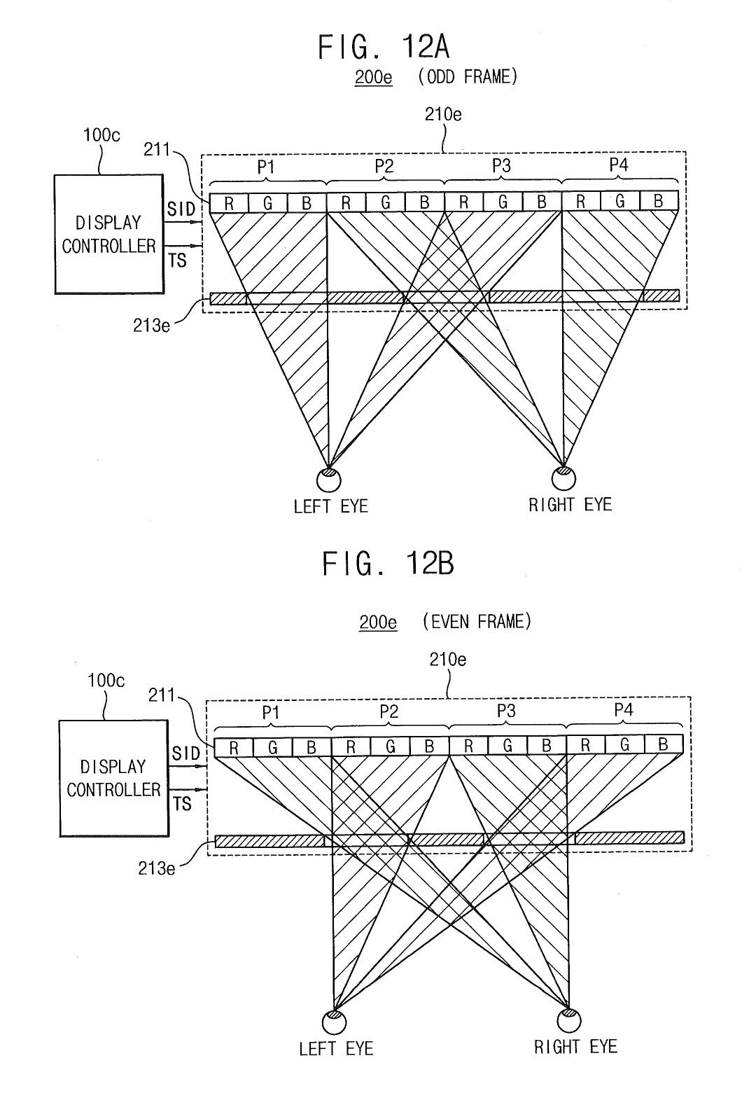

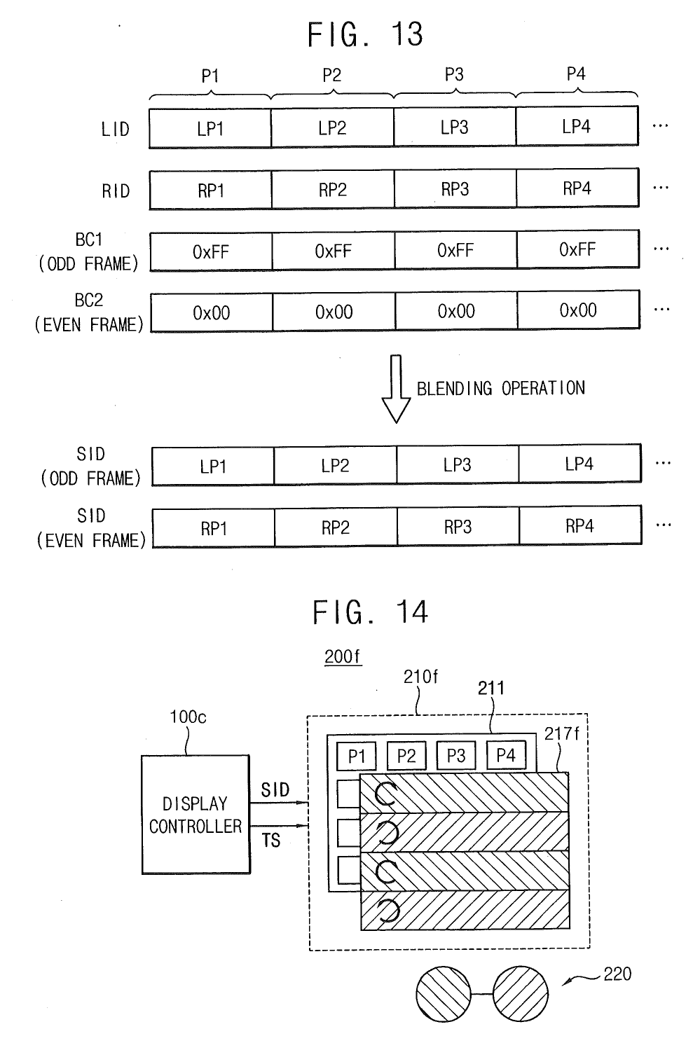

FIGS. 12A and 12B are diagrams illustrating an example of a display system including a display controller of FIG. 10.

Referring to FIGS. 10, 11, 12A and 12B, a display system 200e includes a display controller 100c and a display device 210e.

The display controller 100c performs a blending operation on left-eye image data LID and right-eye image data RID on a pixel basis to generate three-dimensional image data SID. Thus, the display controller 100c may alternately provide, as the three-dimensional image data SID, the left-eye image data LID and the right-eye image data RID to the display device 210e on a pixel basis. Further, the three-dimensional image data SID may have different interleaving orders with respect to an odd frame and an even frame.

The display device 210e receives the three-dimensional image data SID from the display controller 100c, and displays a three-dimensional image based on the three-dimensional image data SID. The display device 210e may include a display panel 211 and a parallax barrier 213e. The display device 210e may interchange pixels that display a left-eye image and pixels that display a right-eye image in each frame by interchanging locations of opening portions and locations of blocking portions of the parallax barrier 213e, based on the state of the timing signal to designate which frame is presently being displayed.

For example, in the odd frame, images displayed by first and third pixels P1 and P3 may be provided to a left-eye of a user, and images displayed by second and fourth pixels P2 and P4 may be provided to a right-eye of the user. Further, in the even frame, the locations of the opening portions and the locations of the blocking portions may be interchanged, the images displayed by the first and third pixels P1 and P3 may be provided to the right-eye, and the images displayed by the second and fourth pixels P2 and P4 may be provided to the right-eye.

In the display system 200e, the display controller 100c may alternately output the left-eye image data LID and the right-eye image data RID as the three-dimensional image data SID on a pixel basis by performing the blending operation, and the three-dimensional image data SID may have different interleaving orders with respect to the odd frame and the even frame. The display device 210e may interchange the pixels that display the left-eye image and the pixels that display the right-eye image by controlling the parallax barrier 213e. Accordingly, the display system 200e according to example embodiments according to the inventive concept may provide a three-dimensional image in a temporal division parallax barrier manner without addition of a complicated circuit.

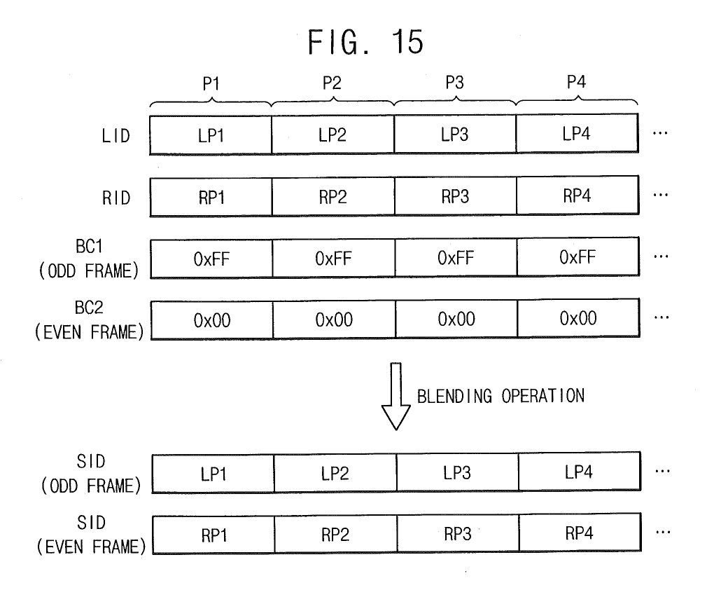

FIG. 13 is a diagram for describing another example of a blending operation performed by a display controller of FIG. 10.

Referring to FIGS. 10 and 13, an image mixing unit 110c may receive, as left-eye image data LID, first through fourth left-eye pixel data LP1, LP2, LP3 and LP4 respectively corresponding to first through fourth pixels P1, P2, P3 and P4, and may receive, as right-eye image data RID, first through fourth right-eye pixel data RP1, RP2, RP3 and RP4 respectively corresponding to the first through fourth pixels P1, P2, P3 and P4. Further, the image mixing unit 110c may receive first pixel blending coefficients PBC11 and PBC12 respectively corresponding to the first through fourth pixels P1, P2, P3 and P4 in an odd line, and may receive second pixel blending coefficients PBC21 and PBC22 respectively corresponding to the first through fourth pixels P1, P2, P3 and P4 in an even line.

For example, the maximum value of the blending coefficients BC may be “0xFF”, the minimum value of the blending coefficients BC may be “0x00”, the first pixel blending coefficients PBC11 and PBC12 may be “0xFF”, “0xFF”, “0xFF” and “0xFF”, respectively, and the second pixel blending coefficients PBC21 and PBC22 may be “0x00”, “0x00”, “0x00” and “0x00”, respectively. In this case, the image mixing unit 110c may output the first through fourth left-eye pixel data LP1, LP2, LP3 and LP4 as the three-dimensional image data SID for the first through fourth pixels P1, P2, P3 and P4 in the odd line, and may output the first through fourth right-eye pixel data RP1, RP2, RP3 and RP4 as the three-dimensional image data SID for the first through fourth pixels P1, P2, P3 and P4 in the even line based on the state of the timing signal to designate which line is presently being displayed.

FIG. 14 is a diagram illustrating another example of a display system including a display controller of FIG. 10.

Referring to FIGS. 10, 13 and 14, a display system 200f includes a display controller 100c, a display device 210f and polarized glasses 220.

The display controller 100c may alternately provide, as the three-dimensional image data SID, left-eye image data LID and right-eye image data RID to the display device 210f on a line basis. For example, the display controller 100c may provide the left-eye image data LID as the three-dimensional image data SID in an odd line, and may provide the right-eye image data RID as the three-dimensional image data SID in an even line.

The display device 210f may include a display panel 211 and a patterned retarder 217f for providing polarized light. In some embodiments according to the inventive concept, the patterned retarder 217f may provide right circular polarized light with respect to the odd line, and may provide left circular polarized light with respect to the even line. For example, the right circular polarized light may be used to display an image of the odd line based on the left-eye image data LID, and the left circular polarized light may be used to display an image of the even line based on the right-eye image data LID. In other embodiments according to the inventive concept, the patterned retarder 217f may provide linearly polarized light instead of the circular polarized light.

A left-eye glass of the polarized glasses 220 may transmit a left-eye image, and a right-eye glass of the polarized glasses 220 may transmit a right-eye image. For example, a right circular polarized filter may be formed on the left-eye glass, and the left-eye glass may transmit the image of the odd line, or the left-eye image. Further, a left circular polarized filter may be formed on the right-eye glass, and the right-eye glass may transmit the image of the even line, or the right-eye image.

In the display system 200f, the display controller 100c may alternately output the left-eye image data LID and the right-eye image data RID as the three-dimensional image data SID on a line basis by performing the blending operation, the display device 210f may use the polarized light to display the left-eye image corresponding to the left-eye image data LID and the right-eye image corresponding to the right-eye image data RID, and the polarized glasses 220 may provide the left-eye image to the left-eye and the right-eye image to the right-eye based on the state of the timing signal to designate which line is presently being displayed.

Accordingly, the display system 200f according to example embodiments according to the inventive concept may provide a three-dimensional image in a polarized glasses manner without addition of a complicated circuit.

FIG. 15 is a diagram for describing still another example of a blending operation performed by a display controller of FIG. 10.

Referring to FIGS. 10 and 15, an image mixing unit 110c may receive, as left-eye image data LID, first through fourth left-eye pixel data LP1, LP2, LP3 and LP4 respectively corresponding to first through fourth pixels P1, P2, P3 and P4, and may receive, as right-eye image data RID, first through fourth right-eye pixel data RP1, RP2, RP3 and RP4 respectively corresponding to the first through fourth pixels P1, P2, P3 and P4. Further, the image mixing unit 110c may receive first pixel blending coefficients PBC11 and PBC12 respectively corresponding to the first through fourth pixels P1, P2, P3 and P4 in an odd frame, and may receive second pixel blending coefficients PBC21 and PBC22 respectively corresponding to the first through fourth pixels P1, P2, P3 and P4 in an even frame.

For example, the maximum value of the blending coefficients BC may be “0xFF”, the minimum value of the blending coefficients BC may be “0x00”, the first pixel blending coefficients PBC11 and PBC12 may be “0xFF”, “0xFF”, “0xFF” and “0xFF”, respectively, and the second pixel blending coefficients PBC21 and PBC22 may be “0x00”, “0x00”, “0x00” and “0x00”, respectively. In this case, the image mixing unit 110c may output the first through fourth left-eye pixel data LP1, LP2, LP3 and LP4 as the three-dimensional image data SID for the first through fourth pixels P1, P2, P3 and P4 in the odd frame, and may output the first through fourth right-eye pixel data RP1, RP2, RP3 and RP4 as the three-dimensional image data SID for the first through fourth pixels P1, P2, P3 and P4 in the even frame based on the state of the timing signal to designate which frame is presently being displayed.

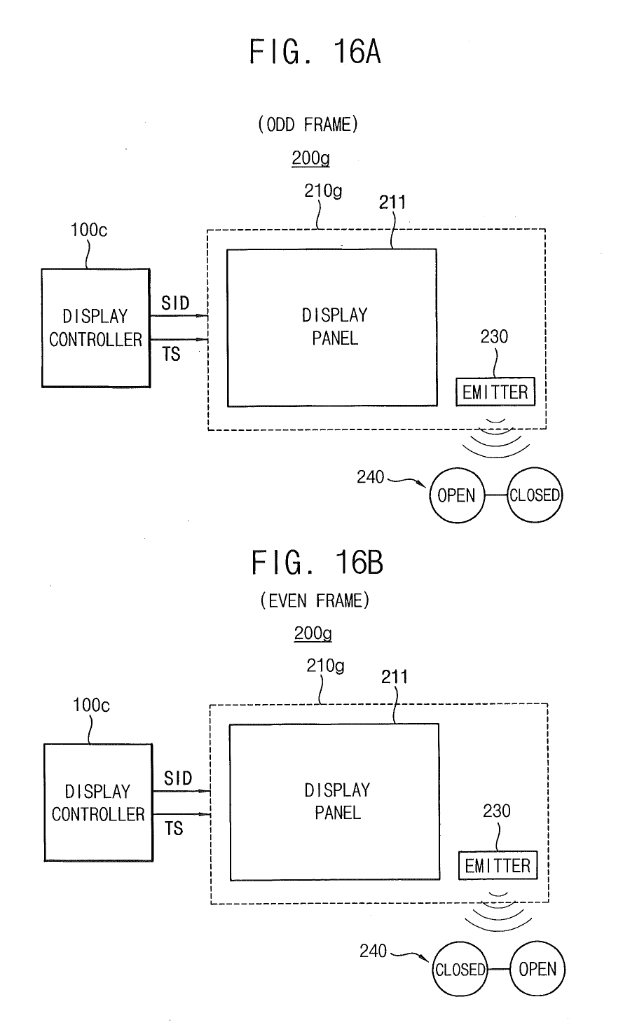

FIGS. 16A and 16B are diagrams illustrating still another example of a display system including a display controller of FIG. 10.

Referring to FIGS. 10, 15, 16A and 16B, a display system 200g includes a display controller 100c, a display device 210g and shutter glasses 240.

The display controller 100c may alternately provide, as the three-dimensional image data SID, left-eye image data LID and right-eye image data RID to the display device 210g on a frame basis. For example, the display controller 100c may provide the left-eye image data LID as the three-dimensional image data SID in an odd frame, and may provide the right-eye image data RID as the three-dimensional image data SID in an even frame.

The display device 210g may include a display panel 211 and an emitter 230 for controlling the shutter glasses 240. For example, the display panel 211 may display a left-eye image based on the left-eye image data LID in the odd frame, and may display a right-eye image based on the right-eye image data RID in the even frame. In the odd frame, the emitter 230 may transmit a control signal to the shutter glasses 240 to open a left-eye glass of the shutter glasses 240 and to close a right-eye glass of the shutter glasses 240 based on the state of the timing signal. Further, in the even frame, the emitter 230 may transmit the control signal to the shutter glasses 240 to open the right-eye glass and to close the left-eye glass based on the state of the timing signal. Accordingly, the left-eye image may be provided to a left-eye of a user in the odd frame, and the right-eye image may be provided to a right-eye of the user in the even frame. The emitter 230 may perform wired or wireless communication with the shutter glasses 240.

In the display system 200g, the display controller 100c may alternately output the left-eye image data LID and the right-eye image data RID as the three-dimensional image data SID on a frame basis by performing the blending operation, the display device 210g may alternately display the left-eye image corresponding to the left-eye image data LID and the right-eye image corresponding to the right-eye image data RID on a frame basis, and the shutter glasses 240 may alternately open the left-eye glass and the right-eye glass on a fame basis. Accordingly, the display system 200g according to example embodiments according to the inventive concept may provide a three-dimensional image in a shutter glasses manner without addition of a complicated circuit.

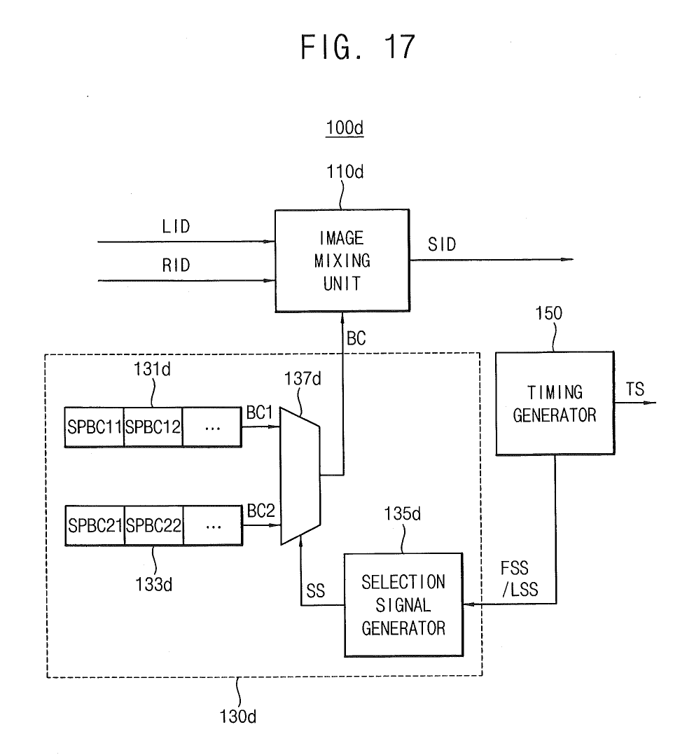

FIG. 17 is a block diagram illustrating a display controller according to example embodiments according to the inventive concept.

Referring to FIG. 17, a display controller 100d includes an image mixing unit 110d, a blending coefficient storing unit 130d and a timing generator 150.

The timing generator 150 generates a timing signal TS to control an operation timing of an external display device. Further, the timing generator 150 may generate a frame start signal FSS indicating a start of a frame of three-dimensional image data and a line start signal LSS indicating a start of a line of the three-dimensional image data.

The blending coefficient storing unit 130d includes a first register 131d, a second register 133d, a selection signal generator 135d and a selector 137d. The first register 131d and the second register 133d may store blending coefficients BC, each of which corresponds to one sub-pixel included in the display device. For example, the first register 131d may store first sub-pixel blending coefficients SPBC11 and SPBC12 respectively corresponding to the sub-pixels, and the second register 133d may store second sub-pixel blending coefficients SPBC21 and SPBC22 respectively corresponding to the sub-pixels. Each of the first register 131d and the second register 133d may have various sizes according to example embodiments according to the inventive concept. The selection signal generator 135d may generate a selection signal SS based on a frame start signal FSS and/or a line start signal LSS from the timing generator 150. The selector 137d may receive the first sub-pixel blending coefficients SPBC11 and SPBC12 as the first blending coefficients BC1 from the first register 131d, may receive the second sub-pixel blending coefficients SPBC21 and SPBC22 as the second blending coefficients BC2 from the second register 133d, and may receive the selection signal SS from the selection signal generator 135d. The selector 137d may selectively provide, as the blending coefficients BS, the first blending coefficients BC1 or the second blending coefficients BC2 to the image mixing unit 110d.

The image mixing unit 110d receives left-eye image data LID and right-eye image data RID, and generates three-dimensional image data SID by performing the blending operation on the left-eye image data LID and the right-eye image data RID using the blending coefficients BC provided from the blending coefficient storing unit 130d. The first blending coefficients BC1 and the second blending coefficients BC2 may be alternately provided from the blending coefficient storing unit 130d to the image mixing unit 110d on a frame basis or on a line basis, and the image mixing unit 110d may perform the blending operation by selectively using the first blending coefficients BC1 or the second blending coefficients BC2. For example, the image mixing unit 110d may output the three-dimensional image data SID where the left-eye image data LID and right-eye image data RID are interleaved in different orders with respect to an odd frame and an even frame.

As described above, the display controller 100d may output the three-dimensional image data SID having different interleaving orders by selectively using the first blending coefficients BC1 or the second blending coefficients BC2. Accordingly, the display controller 100d may support a temporal division type three-dimensional image mode without addition of a complicated circuit.

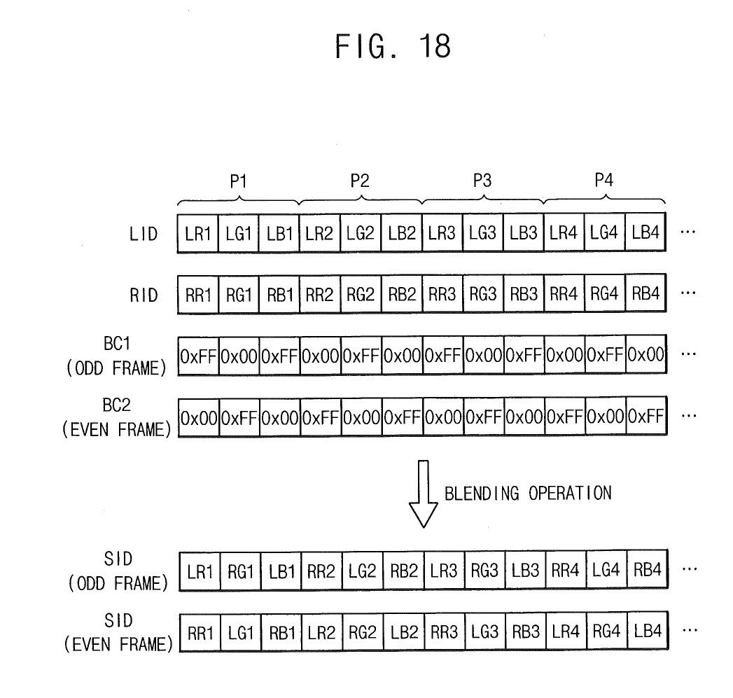

FIG. 18 is a diagram for describing an example of a blending operation performed by a display controller of FIG. 17.

Referring to FIGS. 17 and 18, an image mixing unit 110d may receive first through twelfth left-eye sub-pixel data LR1, LG1, LB1, LR2, LG2, LB2, LR3, LG3, LB3, LR4, LG4 and LB4 as left-eye image data LID, and may receive first through twelfth right-eye sub-pixel data RR1, RG1, RB1, RR2, RG2, RB2, RR3, RG3, RB3, RR4, RG4 and RB4 as right-eye image data RID based on the state of the timing signal to designate which frame is presently being displayed. Further, the image mixing unit 110d may receive first sub-pixel blending coefficients SPBC11 and SPBC12 in an odd frame, and may receive second sub-pixel blending coefficients SPBC21 and SPBC22 in an even frame based on the state of the timing signal to designate which frame is presently being displayed.

For example, the maximum value of the blending coefficients BC may be “0xFF”, the minimum value of the blending coefficients BC may be “0x00”, the first sub-pixel blending coefficients SPBC11 and SPBC12 may be “0xFF”, “0x00”, “0xFF”, “0x00”, “0xFF”, “0x00”, “0xFF”, “0x00”, “0xFF”, “0x00”, “0xFF” and “0x00”, respectively, and the second sub-pixel blending coefficients SPBC21 and SPBC22 may be “0x00”, “0xFF”, “0x00”, “0xFF”, “0x00”, “0xFF”, “0x00”, “0xFF”, “0x00”, “0xFF”, “0x00” and “0xFF”, respectively. In this case, in the odd frame, the image mixing unit 110d may output the first, third, fifth, seventh, ninth and eleventh left-eye sub-pixel data LR1, LB1, LG2, LR3, LB3 and LG4 and the second, fourth, sixth, eighth, tenth and twelfth right-eye sub-pixel data RG1, RR2, RB2, RG3, RR4 and RB4. Further, in the even frame, the image mixing unit 110d may output the first, third, fifth, seventh, ninth and eleventh right-eye sub-pixel data RR1, RB1, RG2, RR3, RB3 and RG4 and the second, fourth, sixth, eighth, tenth and twelfth left-eye sub-pixel data LG1, LR2, LB2, LG3, LR4 and LB4.

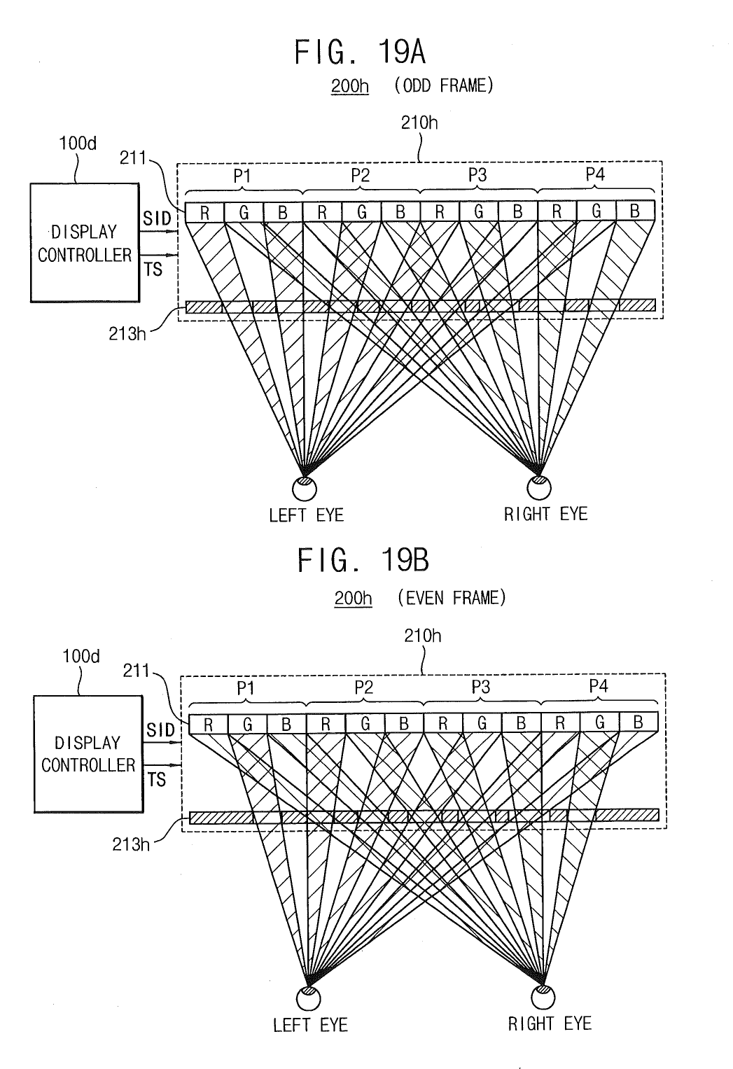

FIGS. 19A and 19B are diagrams illustrating an example of a display system including a display controller of FIG. 17.

Referring to FIGS. 17, 18, 19A and 19B, a display system 200h includes a display controller 100d and a display device 210h.

The display controller 100d may alternately provide, as three-dimensional image data SID, left-eye image data LID and right-eye image data RID to the display device 210h on a sub-pixel basis. Further, the three-dimensional image data SID may have different interleaving orders with respect to an odd frame and an even frame.

The display device 210h may include a display panel 211 and a parallax barrier 213h. The display device 210h may interchange sub-pixels that display a left-eye image and sub-pixels that display a right-eye image in each frame by interchanging locations of opening portions and locations of blocking portions of the parallax barrier 213h.

For example, in the odd frame, images displayed by first, third, fifth, seventh, ninth and eleventh sub-pixels may be provided to a left-eye of a user, and images displayed by second, fourth, sixth, eighth, tenth and twelfth sub-pixels may be provided to a right-eye of the user based on the state of the timing signal to designate which frame is presently being displayed. Further, in the even frame, the images displayed by the first, third, fifth, seventh, ninth and eleventh sub-pixels may be provided to the right-eye, and the images displayed by the second, fourth, sixth, eighth, tenth and twelfth sub-pixels may be provided to the right-eye based on the state of the timing signal to designate which frame is presently being displayed.

In the display system 200h, the display controller 100d may alternately output the left-eye image data LID and the right-eye image data RID as the three-dimensional image data SID on a sub-pixel basis by performing the blending operation, and the three-dimensional image data SID may have different interleaving orders with respect to the odd frame and the even frame. The display device 210h may interchange the sub-pixels that display the left-eye image and the sub-pixels that display the right-eye image by controlling the parallax barrier 213h based on the state of the timing signal to designate which frame is presently being displayed. Accordingly, the display system 200h according to example embodiments according to the inventive concept may provide a three-dimensional image in a temporal division parallax barrier manner without addition of a complicated circuit.

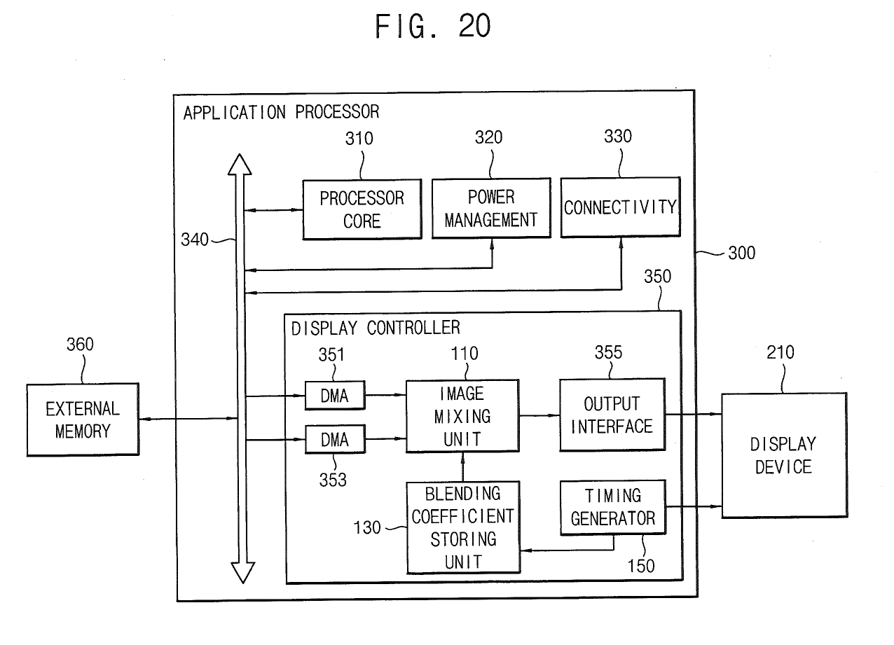

FIG. 20 is a block diagram illustrating an application processor according to example embodiments according to the inventive concept.

Referring to FIG. 20, an application processor 300 includes a processor core 310, a power management unit 320, a connectivity unit 330, a bus 340 and a display controller 350.

The processor core 310 may perform various computing functions or tasks. For example, the processor core 310 may be a microprocessor core, a central process unit (CPU) core, a digital signal processor core, or the like. The processor core 310 may control the power management unit 320, the connectivity unit 330 and the display controller 350 via the bus 340. The processor core 310 may be coupled to a cache memory inside or outside the processor core 310. In some embodiments according to the inventive concept, the application processor 300 may be a multi-core processor, such as a dual-core processor, a quad-core processor, a hexa-core processor, etc.

The power management unit 320 may manage a power state of the application processor 300. For example, the power management unit 320 may control the application processor 300 to have operating in various power states, such as a normal power state, an idle power state, a stop power state, a sleep power state, etc. The connectivity unit 330 may provide various interfaces, such as IIS, IIC, DART, GPIO, IrDa, SPI, HIS, USB, MMC/SD, etc.

The display controller 350 includes an image mixing unit 110 and a blending coefficient storing unit 130. The image mixing unit 110 may provide three-dimensional image data by performing a blending operation on left-eye image data and right-eye image data using blending coefficients stored in the blending coefficient storing unit 130. Accordingly, the display controller 350 may support a three-dimensional image mode without addition of a complicated circuit.

In some embodiments according to the inventive concept, the display controller 350 may further include a first direct memory access unit 351 that receives the left-eye image data by directly accessing an external memory device 360, and a second direct memory access unit 353 that receives the right-eye image data by directly accessing the external memory device 360. The first direct memory access unit 351 and the second direct memory access unit 353 may read the left-eye image data and the right-eye image data from the memory device 360 via the bus 340 without the intervention of the processor core 310.

The display controller 350 may further include a timing generator 150 that generates a timing signal for controlling an operation timing of an external display device 210, and an output interface unit 355 for providing the display device 210 with the three-dimensional image data output from the image mixing unit 110. According to example embodiments according to the inventive concept, the output interface unit 355 may communicate with the display device 210 via various interfaces, such as a digital visual interface (DVI), a high definition multimedia interface (HDMI), a mobile industry processor interface (MIPI), a DisplayPort, etc.

The display controller 350 may support various types of three-dimensional image modes. For example, the display controller 350 may support a spatial division parallax barrier type three-dimensional image mode as illustrated in FIGS. 4 and 8, a spatial division lenticular lens type three-dimensional image mode as illustrated in FIGS. 5 and 9, a temporal division parallax barrier type three-dimensional image mode as illustrated in FIGS. 12A, 12B, 19A and 19B, a polarized glasses type three-dimensional image mode as illustrated in FIG. 14, a shutter glasses type three-dimensional image mode as illustrated in FIGS. 16A and 16B, etc.

As described above, the display controller 350 according to example embodiments according to the inventive concept may support various types of three-dimensional image modes without addition of a complicated circuit.

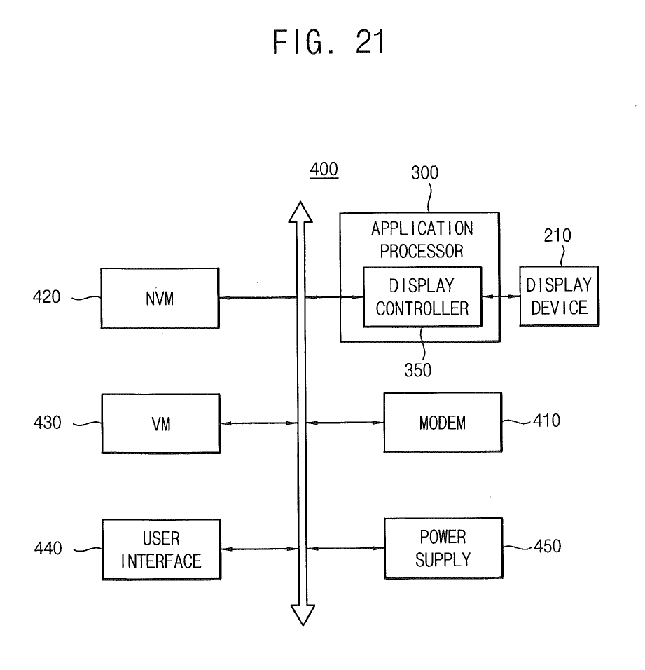

FIG. 21 is a block diagram illustrating a mobile system according to example embodiments according to the inventive concept.

Referring to FIG. 21, a mobile system 400 includes a modem 410 (e.g., baseband chipset), a nonvolatile memory device 420, a volatile memory device 430, a user interface 440, a power supply 450, an application processor 300 and a display device 210. According to example embodiments according to the inventive concept, the mobile system 400 may be any mobile system, such as a mobile phone, a smart phone, a personal digital assistant (PDA), a portable multimedia player (PMP), a digital camera, a portable game console, a music player, a camcorder, a video player, etc.

The modem 410 may demodulate wireless data received via an antenna to provide the demodulated data to the application processor 300, and may modulate data received from the application processor 300 to provide the modulated data to a remote device via the antenna. For example, the modem 410 may be a modem processor that provides wired or wireless communication, such as GSM, GPRS, WCDMA, HSxPA, etc. The application processor 300 may execute applications that provide an internet browser, a three-dimensional map, a game, a video, etc. According to example embodiments according to the inventive concept, the modem 410 and the application processor 300 may be implemented as one chip, or may be implemented as separate chips.

The nonvolatile memory device 420 may store a boot code for booting the mobile system 400. For example, the nonvolatile memory device 420 may be implemented by an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), a ferroelectric random access memory (FRAM), etc. The volatile memory device 430 may store data transferred by the modem 410 or data processed by the application processor 300, or may operate as a working memory. For example, the nonvolatile memory device 430 may be implemented by a dynamic random access memory (DRAM), a static random access memory (SRAM), a mobile DRAM, etc.

The application processor 300 may include a display controller 350 that controls the display device 210. For example, the display controller 350 may receive left-eye image data and right-eye image data from the volatile memory device 430 or the modem 410, and may generate three-dimensional image data by performing a blending operation on the left-eye image data and the right-eye image data. The display controller 350 may provide the three-dimensional image data to the display device 210, and the display device 210 may display a three-dimensional image based on the three-dimensional image data.

The user interface 440 may include at least one input device, such as a keypad, a touch screen, etc., and at least one output device, such as a display device, a speaker, etc. The power supply 450 may supply the mobile system 400 with power. In some embodiments according to the inventive concept, the mobile system 400 may further include a camera image processor (CIS).

In some embodiments according to the inventive concept, the mobile system 400 and/or components of the mobile system 400 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

In some embodiments according to the inventive concept, the display controller 350 may be applied to any computing system, such as a digital television, a three-dimensional television, a personal computer, a home appliance, etc.

The foregoing is illustrative of example embodiments according to the inventive concept and is not to be construed as limiting thereof. Although a few example embodiments according to the inventive concept have been described, those skilled in the art will readily appreciate that many modifications are possible in the example embodiments according to the inventive concept without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments according to the inventive concept and is not to be construed as limited to the specific example embodiments according to the inventive concept disclosed, and that modifications to the disclosed example embodiments according to the inventive concept, as well as other example embodiments according to the inventive concept, are intended to be included within the scope of the appended claims.

What is claimed is:

1. A display controller, comprising:
a blending coefficient storing unit configured to store blending coefficients; and
an image mixing unit configured to receive left-eye image data and right-eye image data, and to generate three-dimensional image data by performing a blending operation on the left-eye image data and the right-eye image data using the blending coefficients stored in the blending coefficient storing unit.

2. The display controller of claim 1, wherein the blending coefficient storing unit comprises:
a register configured to store the blending coefficients, and
wherein each of the blending coefficients stored in the register corresponds to one pixel.

3. The display controller of claim 1, wherein the blending coefficient storing unit comprises:
a register configured to store the blending coefficients, and
wherein each of the blending coefficients stored in the register corresponds to one sub-pixel.

4. The display controller of claim 1, further comprising:
a timing generator configured to generate a frame start signal indicating a start of a frame of the three-dimensional image data and/or a line start signal indicating a start of a line of the three-dimensional image data.

5. The display controller of claim 4, wherein the blending coefficients include odd frame blending coefficients corresponding to an odd frame of the three-dimensional image data and even frame blending coefficients corresponding to an even frame of the three-dimensional image data, and wherein the blending coefficient storing unit comprises:
a selection signal generator configured to receive the frame start signal from the timing generator, and to generate a selection signal in response to the frame start signal;
a first register configured to store the odd frame blending coefficients;
a second register configured to store the even frame blending coefficients; and
a selector configured to selectively provide the odd frame blending coefficients or the even frame blending coefficients to the image mixing unit in response to the selection signal.

6. The display controller of claim 4, wherein the blending coefficients include odd line blending coefficients corresponding to an odd line of the three-dimensional image data and even line blending coefficients corresponding to an even line of the three-dimensional image data, and wherein the blending coefficient storing unit comprises:
a selection signal generator configured to receive the line start signal from the timing generator, and to generate a selection signal in response to the line start signal;
a first register configured to store the odd line blending coefficients;
a second register configured to store the even line blending coefficients; and
a selector configured to selectively provide the odd line blending coefficients or the even line blending coefficients to the image mixing unit in response to the selection signal.

7. The display controller of claim 1 further comprising:
An output interface unit configured to provide the three-dimensional image data to an external display device.

8. The display controller of claim 1, further comprising:
a first direct memory access unit configured to receive the left-eye image data by directly accessing an external memory device; and
a second direct memory access unit configured to receive the right-eye image data by directly accessing the external memory device.

9. The display controller of claim 1, wherein the image mixing unit is configured to perform an alpha blending operation as the blending operation.

10. The display controller of claim 1, wherein the image mixing unit is configured to perform the blending operation using an equation,
$${}_{“} S I D = {\frac{1}{MAX - MIN} [ L I D * ( B C - MIN ) + R I D * ( MAX - B C ) ]}_{”} ,$$
where SID represents the three-dimensional image data, LID represents the left-eye image data, RID represents the right-eye image data, BC represents the blending coefficients, MAX represents a maximum value of the blending coefficients, and MIN represents a minimum value of the blending coefficients.

11. A display system, comprising:
a display controller configured to receive left-eye image data and right-eye image data, to store blending coefficients, and to generate three-dimensional image data by performing a blending operation on the left-eye image data and the right-eye image data using the blending coefficients; and
a display device configured to display a three-dimensional image based on the three-dimensional image data.

12. The display system of claim 11, wherein the display controller is configured to alternately provide, as the three-dimensional image data, the left-eye image data and the right-eye image data to the display device on a pixel basis, and
wherein the display device is configured to display the three-dimensional image based on the three-dimensional image data by using a parallax barrier or a lenticular lens.

13. The display system of claim 11, wherein the display controller is configured to alternately provide, as the three-dimensional image data, the left-eye image data and the right-eye image data to the display device on a sub-pixel basis, and
wherein the display device is configured to display the three-dimensional image based on the three-dimensional image data by using a parallax barrier or a lenticular lens.

14. The display system of claim 11, wherein the display controller is configured to alternately provide, as the three-dimensional image data, the left-eye image data and the right-eye image data to the display device on a line basis, and
wherein the display device is configured to display the three-dimensional image based on the three-dimensional image data for use with polarized glasses.

15. The display system of claim 11, wherein the display controller is configured to alternately provide, as the three-dimensional image data, the left-eye image data and the right-eye image data to the display device on a frame basis, and
wherein the display device is configured to display the three-dimensional image based on the three-dimensional image data for use with shutter glasses.

16. A mobile display controller, comprising:
a blending coefficient storing unit configured to store blending coefficients; and
an image mixing unit configured to receive left-eye image data and right-eye image data, and to generate three-dimensional image data by blending left-eye image data and the right-eye image data together responsive to the blending coefficients, wherein the blending coefficient indicates different multipliers for the left-eye image data and right-eye image data.

17. The mobile display controller of claim 16, wherein the blending coefficients include odd line blending coefficients corresponding to an odd line of the three-dimensional image data, even line blending coefficients corresponding to an even line of the three-dimensional image data, odd frame blending coefficients corresponding to an odd frame of the three-dimensional image data, and even frame blending coefficients corresponding to an even frame of the three-dimensional image data, wherein the blending coefficient storing unit comprises:
a selection signal generator configured to receive the line start signal and the frame start signal from a timing generator, and to generate a selection signal in response to the line start signal and the frame start signal;
a first register configured to store the odd line blending coefficients;
a second register configured to store the even line blending coefficients;
a third register configured to store the odd frame blending coefficients;
a fourth register configured to store the even frame blending coefficients; and
a selector configured to selectively provide the odd line blending coefficients, the even line blending coefficients, the odd frame blending coefficients, and the even frame blending coefficients to the image mixing unit in response to the selection signal.

18. The mobile display controller of claim 16, wherein the blending coefficient storing unit and the image mixing unit are integrated into a single integrated circuit device package.

19. The mobile display controller of claim 16, wherein the blending coefficients correspond to one sub-pixel.

20. The display controller of claim 18, further comprising:
a timing generator, included in the single integrated circuit device package, configured to generate a frame start signal indicating a start of a frame of the three-dimensional image data and/or a line start signal indicating a start of a line of the three-dimensional image data.
